(19) United States
(12) Patent Application Publication
(10) Pub. No.: US 2024/0222772 A1
(43) Pub. Date: Jul. 4, 2024

(54) BATTERY ENCLOSURES FOR ELECTRIC VEHICLES

(71) Applicant: GM GLOBAL TECHNOLOGY OPERATIONS LLC, Detroit, MI (US)

(72) Inventors: Lu HUANG, Troy, MI (US); Hui WANG, Novi, MI (US); Hui-ping WANG, Troy, MI (US); Thomas M SIBERSKI, White Lake, MI (US); Blair E. CARLSON, Ann Arbor, MI (US); Yunzhi XU, Sterling Heights, MI (US)

(21) Appl. No.: 18/090,116

(22) Filed: Dec. 28, 2022

(51) Int. Cl. H01M 50/249; B60L 50/64; H01M 10/613

(52) U.S. Cl. CPC H01M 50/249; B60L 50/64; H01M 10/613

(57) ABSTRACT

A battery enclosure to house a battery pack of an electric vehicle includes a bottom plate, a battery pack including multiple batteries or battery modules, a frame enclosure at least partially surrounding the battery pack, the frame enclosure connected with the bottom plate, the frame enclosure including at least a first side wall and a second side wall, and multiple cross members each extending between the first side wall and the second side wall. The battery enclosure includes a top plate configured to cover the multiple structural cross members and at least a portion of the battery pack. The top plate is connected with the frame enclosure and includes multiple ridges protruding from a top surface of the top plate, each ridge defining a channel extending parallel to the top surface of the top plate, and each channel configured to facilitate flow of a heat transfer medium through the channel.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery enclosures for electric vehicles, including battery enclosures having structural load paths and integrated heat transfer.

Battery enclosures are a key component of electric vehicles (EVs) to house and protect the battery pack and other systems, such as thermal components, electronics, and battery management system (BMS) components. Designing a highly efficient EV battery enclosure includes challenges in the integration of safety, thermal efficiency, and pack energy density. A battery pack may refer to a group of batteries or battery modules that store energy.

### SUMMARY

A battery enclosure to house a battery pack of an electric vehicle includes a bottom plate including at least a top surface and a bottom surface, a battery pack including multiple batteries or battery modules configured to store energy for the electric vehicle, a frame enclosure at least partially surrounding the battery pack, the frame enclosure connected with the bottom plate, the frame enclosure including at least a first side wall and a second side wall opposite the first side wall, and multiple cross members, each cross member extending between the first side wall and the second side wall. The battery enclosure includes a top plate configured to cover the multiple structural cross members and at least a portion of the battery pack, the top plate connected with the frame enclosure, the top plate including multiple ridges protruding from a top surface of the top plate, each ridge defining a channel extending parallel to the top surface of the top plate, and each channel configured to facilitate flow of a heat transfer medium through the channel.

In other features, the battery enclosure includes a tray on the top surface of the bottom plate, the tray configured to house the battery pack, the tray including at least a first tray side wall and a second tray side wall opposite the first tray side wall. The frame enclosure at least partially surrounds the tray, and each cross member extends from the first tray side wall to the second tray side wall.

In other features, the heat transfer medium includes at least one of a coolant liquid and air. In other features, the bottom plate includes multiple ridges protruding from the bottom surface, each ridge of the bottom plate defines a channel extending parallel to the bottom surface, and each channel of the bottom plate is configured to facilitate flow of the heat transfer medium through the channel.

In other features, the battery enclosure includes at least one air deflector angled to direct airflow from beneath the electric vehicle into at least one channel of the bottom plate. In other features, each ridge includes two channel side walls extending upwards from the top surface of the top plate, and an upper wall connected between the two channel side walls, and the upper wall is parallel with the top surface of the top plate.

In other features, the battery enclosure includes a tube extending through at least one channel to provide a flow of coolant liquid through the at least one of the channels. In other features, a first portion of the multiple ridges extend in a first direction parallel to a length dimension of the top plate, and a second portion of the multiple ridges extend in a second direction perpendicular to the first direction.

In other features, each of the multiple ridges in the first portion intersects at least one of the multiple ridges in the second portion. In other features, the top plate is configured to connect to a floor pan of a body of the electric vehicle to provide structural support for the top plate.

In other features, the tray is configured to hermetically seal the battery pack within the battery enclosure. In other features, the frame enclosure is configured to fully enclose the battery pack with the bottom plate, to hermetically seal the battery pack.

A battery enclosure for a battery pack of an electric vehicle includes a bottom plate including at least a top surface and a bottom surface, a battery pack including multiple batteries or battery modules configured to store energy for the electric vehicle, a frame enclosure at least partially surrounding the battery pack, the frame enclosure connected with the bottom plate, the frame enclosure including at least a first side wall and a second side wall opposite the first side wall, and multiple cross members. Each cross member extends between the first side wall and the second side wall, each cross member defines multiple channels extending along the cross member, and each channel is configured to facilitate flow of a heat transfer medium through the channel. The battery enclosure includes a top plate configured to cover the multiple cross members and at least a portion of the battery pack, the top plate connected with the frame enclosure.

In other features, the battery enclosure includes a tray on the top surface of the bottom plate, the tray configured to house the battery pack, the tray including at least a first tray side wall and a second tray side wall opposite the first tray side wall, and each cross member extends from the first tray side wall to the second tray side wall.

In other features, the heat transfer medium includes at least one of a coolant liquid and air. In other features, each of the multiple batteries or battery modules is between two of the multiple cross members. In other features, a height of each cross member between the tray and a bottom surface of the top plate is greater than a width of the cross member.

In other features, the battery enclosure includes multiple side brackets, wherein each side bracket is located between the frame enclosure and the first tray side wall or the second tray side wall, and each side bracket is aligned with an end of one or more of the multiple cross members to transfer load to one or more of the multiple cross members.

In other features, the frame enclosure is on an outer periphery of the battery pack, and the frame enclosure defines a crumple zone configured to allow deformation of the frame enclosure in response to a side impact of the battery enclosure.

A battery enclosure for a battery pack of an electric vehicle includes a bottom plate including at least a top surface and a bottom surface, the bottom plate including multiple ridges protruding from the bottom surface, each ridge defining a channel extending parallel to the bottom surface, a battery pack including multiple batteries or battery modules configured to store energy for the electric vehicle, a frame enclosure at least partially surrounding the battery pack, the frame enclosure connected with the bottom plate, the frame enclosure including at least a first side wall and a second side wall opposite the first side wall, and multiple cross members. Each cross member extends between the first side wall and the second side wall. The battery enclosure includes a top plate configured to cover the multiple cross members and at least a portion of the battery pack, the top plate connected with the frame enclosure, the top plate including multiple ridges protruding from a top surface of the top plate, and each ridge of the top plate defining a channel extending parallel to the top surface of the top plate.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an orthogonal view of an example battery enclosure for electric vehicles, according to the present disclosure;

FIG. 2 is an exploded view of the example battery enclosure of FIG. 1;

FIG. 3 is another exploded view of the example battery enclosure of FIG. 1, illustrating example load sharing paths according to the present disclosure;

FIG. 4A is a cross-sectional view of the example battery enclosure of FIG. 1;

FIG. 4B is a cross-sectional view of a portion of the example battery enclosure f FIG. 4A, taken at detail ‘A’ in FIG. 4A;

FIG. 5 is an exploded view illustrating example heating and/or cooling paths in a battery enclosure, according to the present disclosure; and

FIG. 6 is a cross-sectional view of a portion of the example battery enclosure of FIG. 5, taken at detail ‘B’ in FIG. 5.

In the drawings, reference numbers may be reused to identify similar and/or identical elements.

### DETAILED DESCRIPTION

In some example embodiments of the present disclosure, a battery enclosure for an electric vehicle enables load bearing and force distribution via structural components, including but not limited to a peripheral frame enclosure, multiple cross members, a bottom plate (e.g., a bottom shear plate) and a top plate (e.g., a top shear plate). Heat transfer capabilities may be integrated with the structural components of the battery enclosure, to increase heating/cooling efficiency. Integration of heat transfer capabilities to structural components may reduce a volume occupied by thermal components, freeing up space to increase battery pack energy density.

Example battery enclosures may be used with any suitable vehicle types, including unibody platforms, body-on-frame platforms, etc. Example battery enclosures may be compatible with various suitable battery types. Example materials for battery enclosures may include metallic and/or non-metallic materials.

In various implementations, a structural top shear plate is designed to close the top of the battery enclosure and provides load bearing support for the battery pack. The top shear plate may be structurally connected and/or integrated with, e.g., a floor pan of a body of the vehicle, allowing for engagement of the structural components of the car body during a crash event, to provide additional structural support for the battery pack. In various implementations, the top shear plate and/or a bottom plate may be a single-layer or multi-layer structure.

In some example embodiments, the battery enclosure may include multiple cross members. Each cross member may have a slim profile (e.g., a greater height than width), which may increase an effective cross-sectional area, increase an overall stiffness of the battery enclosure structure, and allow for a greater number of cross members to be spread throughout the battery enclosure.

The battery enclosure may include a frame enclosure located on the outer periphery of the battery pack, which fully or partially encloses the battery pack, where the frame enclosure is connected between the top shear plate and the bottom shear plate. The frame enclosure may provide a ‘crumple zone’ to absorb impact energy from side impacts to the battery enclosure, and add additional clearance to protect the battery pack during a crash event.

For example, the frame enclosure may define a space between a side wall of the frame enclosure and the battery pack, to allow for partial deformation of the frame enclosure without damaging the battery pack. In various implementations, the frame enclosure may be connected and/or integrated with a frame of the vehicle, to provide additional structural support for the battery enclosure.

A battery tray may be included to house a battery pack, battery management system (BMS), etc. For example, the battery tray may be supported on a top surface of the bottom shear plate, and may include side walls and end walls to surround the battery pack. The battery tray may be configured to hermetically seal the battery pack within the battery enclosure. In various implementations, the battery tray may include one or more stiffening features, e.g., in vertical walls, for added stiffness and clearance.

Load distribution may be facilitated by using stiff top and/or bottom portions inside of a frame enclosure in order to transfer impact to top and/or bottom shear plates, e.g., via contact between the frame enclosure and the top and/or bottom shear plates. Additionally, or alternatively, an impact load may be distributed from the frame enclosure to cross members, e.g., via brackets located between the frame enclosure and the cross members. The cross members may be connected to the top and bottom shear plates to provide further stiffening and more balanced load sharing.

In various implementations, example battery enclosures may provide additional clearance and stiffness, such that the example battery enclosures may serve as a barrier to resist the deformation of body cross bars and rockers, thereby inhibiting or preventing compression and intrusion of body structures into the battery pack.

In some example embodiments, high-speed airflow that occurs when driving the vehicle may be leveraged to provide a cooling effect for the battery pack. For example, the bottom shear plate may include one or more offset features (e.g., ridges, etc.) that define channels for regulating airflow along the bottom shear plate.

In various implementations, one or more air deflectors may be angled, positioned, etc. to guide air flowing beneath the vehicle into the channels of the bottom shear plate. For example, air deflectors may be coupled to an underside of the vehicle upstream of the bottom shear plate, with surfaces positioned to cause airflow to be diverted towards openings of the channels of the bottom shear plate.

The cross members may provide a heat transfer function, by incorporating channels, tubes, etc. in the cross members and/or on surfaces of the cross members, to provide additional cooling/heating for the battery pack in contact with or adjacent to surfaces of the cross members.

The offset features of the top shear plate and/or bottom shear plate may be configured to facilitate flow of cooling/heating agents (such as coolant liquid, air, etc.), to improve heat transfer.

As described above, the top shear plate of one or more layers may be used in place of the cover of the battery enclosure to provide structural support for load bearing during a crash event. Multiple slim cross members may also be used as structural components for enhanced stiffness and impact resistance.

A frame enclosure may surround a periphery of the battery pack and/or tray, and include a “soft” middle structure that serves as a crumple zone to absorb impact energy. The frame enclosure may include “strong” top and/or bottom portions to transfer loads to other structural components, such as the top and/or bottom shear plates and the cross members.

Multiple brackets may engage the load transferring features of the frame enclosure in order to pass impact loads to the cross members. In various implementations, the structural battery enclosure may have all load-bearing components inter-connected with one another, to work cohesively to form a designed path for impact load absorption and distribution. In various implementations, example battery enclosures may include clearances via stiffening offset features, which may be located, e.g., on side walls of a tray surrounding the battery pack, to provide added protection during a crash event.

In some example embodiments, the cross members may integrate heat transfer functionality (e.g., cooling and heating) in an inner volume of the cross members, in order to cool/heat in vertical and/or horizontal directions. Heat transfer tubing may be located in, e.g., channels of the structural components, such as channels of the cross members and the top and bottom shear plates. Enhanced or optimized routes of heat transfer tubing may be determined based on, e.g., computer-aided engineering (CAE) analysis to identify smallest displacement locations. Example locations for placing heating/cooling tubing may include, but are not limited to, free space between the frame enclosure and side walls of a battery tray, channels within an upper and/or lower shear plate, channels in cross members, etc.

For example, an air cooling function may be integrated in the bottom shear plate by utilizing the offset features as channels to regulate the airflow to the bottom of the battery pack. An air deflecting component may be used to direct air to the bottom of the battery pack for bottom plate air cooling. Integrated cooling/heating capabilities in the top shear plate may facilitate supplementary thermal transmission options.

Some example embodiments herein may provide one or more benefits, such as a battery enclosure having a high system integration efficiency, high pack energy density, load paths that engage an upper structure of the battery enclosure to share the impact of a crash event, increase heat transfer functionality to allow for faster heating/cooling and provide improved fast charging, etc.

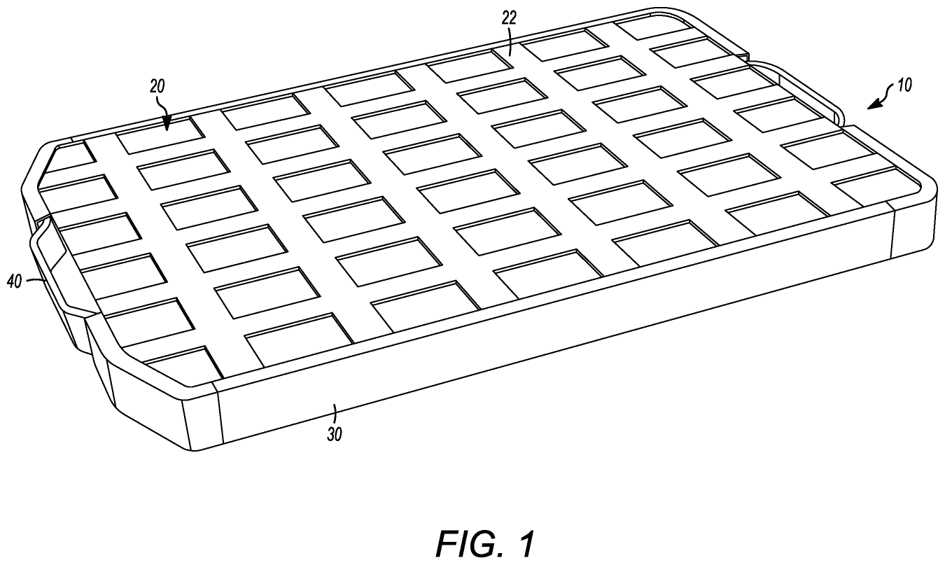

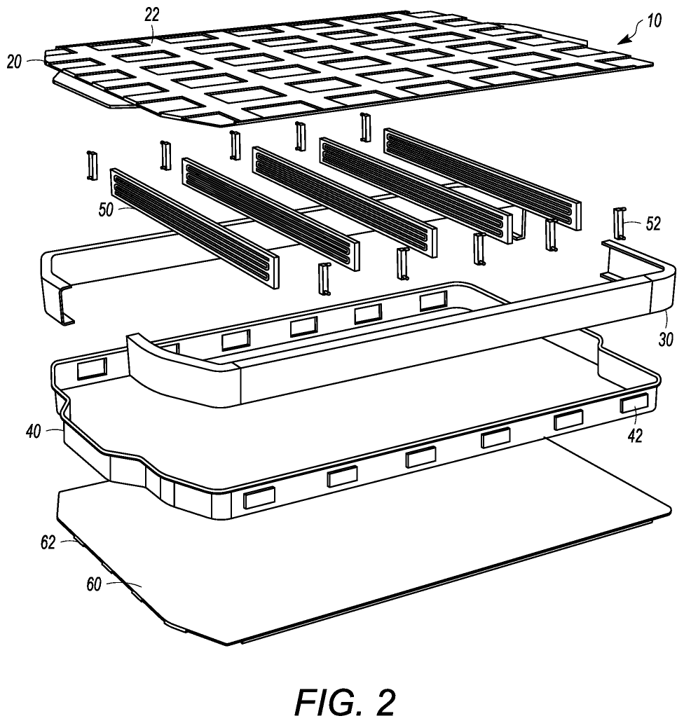

Referring now to FIGS. 1 and 2, a battery enclosure 10 according to an example embodiment of the present disclosure includes a top plate 20, a frame enclosure 30, a tray 40, cross members 50, and a bottom plate 60. The top plate 20 may be considered as a structural top plate that may consist of multiple layers and provide load-bearing support for the battery enclosure 10, compared to conventional battery covers that do not provide structural support. While the tray 40 is illustrated in the example embodiment, the tray 40 is an optional component and may not be included in various implementations. If the tray is absent, the frame enclosure 30 may fully enclose the battery pack to provide hermetic sealing.

As shown in FIG. 2, the tray 40 (e.g., a battery tray) is located on a top surface of the bottom plate 60, and may be supported by the bottom plate 60. The tray 40 is configured to house the battery pack, which may include multiple batteries or battery modules distributed throughout the tray 40. In various implementations, side walls and end walls of the tray 40 may correspond to a height of the battery pack, or may be taller or shorter than a height of the battery pack.

In some embodiments, the tray 40 may hermetically seal the battery pack within the battery enclosure 10, while only emergency venting is allowed. For example, the tray 40 may include one or more sealing features that hermetically seal an interior of the tray 40 (e.g., where the battery pack is located), from ambient air external to the battery enclosure 10. Hermetic sealing may be provided between the tray 40 and the top plate 20, to protect the interior of the tray 40. In various implementations, vent valves may be included to release gas from the battery enclosure 10.

The frame enclosure 30 surrounds at least a portion (or all) of the tray 40. For example, a shape of the frame enclosure 30 may correspond to a perimeter shape of the walls of the tray 40, and the frame enclosure 30 optionally includes a specified clearance space between the walls of the frame enclosure 30 and the walls of the tray 40. In various implementations, the frame enclosure 30 may be a fully or partially closed structure. When the tray 40 is absent, the frame enclosure 30 may enclose the batteries or battery modules and provide hermetic sealing.

The frame enclosure 30 may be considered as a structure that transfers an impact load from a side wall of the fame enclosure to the cross members 50. In various implementations, the additional clearance of the crumple zone may absorb impact energy and protect the battery pack. In a side impact the frame enclosure 30 is engaged to serve as a crumple zone, where stiffer top and/or bottom parts pass portions of the impact load to other structural components such as the top plate 20, the bottom plate 60, and cross members 50.

The frame enclosure 30 may have a two-piece construction that is connected during manufacturing, may have a one-piece construction, may include more than two separate sections that are joined together, etc. Corners of the frame enclosure 30 may be designed to have shapes that correspond to a location in the vehicle for housing the battery enclosure, shapes that provide enhanced stiffness via rounded corners, etc.

The frame enclosure 30 may be connected to the bottom plate 60 (e.g., a bottom shear plate) and the top plate 20 (e.g., a top shear plate). The frame enclosure may be connected using any suitable connecting implementation, such as bolts, welds, adhesive, friction, or other contact fits.

In some example embodiments, the frame enclosure 30 may include a ridge, lip, etc. to receive the top plate 20 and/or the bottom plate 60. A strong connection may be designed between the frame enclosure 30 and the top plate 20 and/or bottom plate 60 to facilitate transferring an impact load from the frame enclosure 30 to the top plate 20 and/or bottom plate 60.

For example, the frame enclosure 30 may engage both the top plate 20 and the bottom plate 60. In various implementations, the frame enclosure 30 may include a recess that the top plate 20 can drop into. Similarly, the bottom plate 60 may sit in a recess channel of the frame enclosure 30.

The cross members 50 extend between opposite side walls of the tray 40. The cross members 50 may be substantially parallel to one another, and may be spaced approximately equal distances from one another, although other embodiments may use different arrangements of the cross members 50. In various implementations, a distance between two adjacent cross members 50 may be approximately equal to or larger than a width of a battery or a battery module, such that the battery or battery module can be positioned between the two cross members 50.

Each cross member 50 may have a slim cross-sectional profile, with a height that is greater than a width of the cross member 50. For example, a height of the cross member 50 between the tray 40 and the top plate 20 may be greater than a width of the cross member 50.

Using narrow cross members 50 may save space within the battery enclosure, thereby increasing the space used for batteries and increasing the energy density. Narrower cross members 50 may allow for using more cross members 50 compared to conventional bulkier supports, to provide enhanced stiffness to the battery enclosure 10.

For example, with narrower cross members 50, an increased number of cross members 50 may be spaced throughout the tray 40 to provide structural support at more locations within the battery enclosure 10. Although FIG. 2 illustrates five cross members 50, other embodiments may include more or less cross members.

As shown in FIG. 2, the battery enclosure 10 may include multiple brackets 52. Each bracket 52 may be positioned between a side wall of the battery tray 40 and a side wall of the frame enclosure 30. The brackets 52 may each be aligned with an end of one of the cross members 50, to transfer load to the cross members 50. For example, each bracket 52 may provide a structural connection between the frame enclosure 30 and one of the cross members 50, to facilitate transferring an impact load from the frame enclosure to the cross member 50 in the event of, e.g., a vehicle side impact crash.

The top plate 20 covers the top surfaces of the cross members 50, and at least a portion (or all) of the tray 40. For example, the top plate 20 may cover the battery pack housed in the tray 40, as well as proving structural connection support with the cross members 50 and the frame enclosure 30. In various implementations, the top plate 20 may be connected to the frame enclosure 30 and/or the cross members 50 via bolts, screws, rivets, welds, adhesive, etc. In various implementations, the top plate 20 may be a single layer structure, or a multi-layer structure.

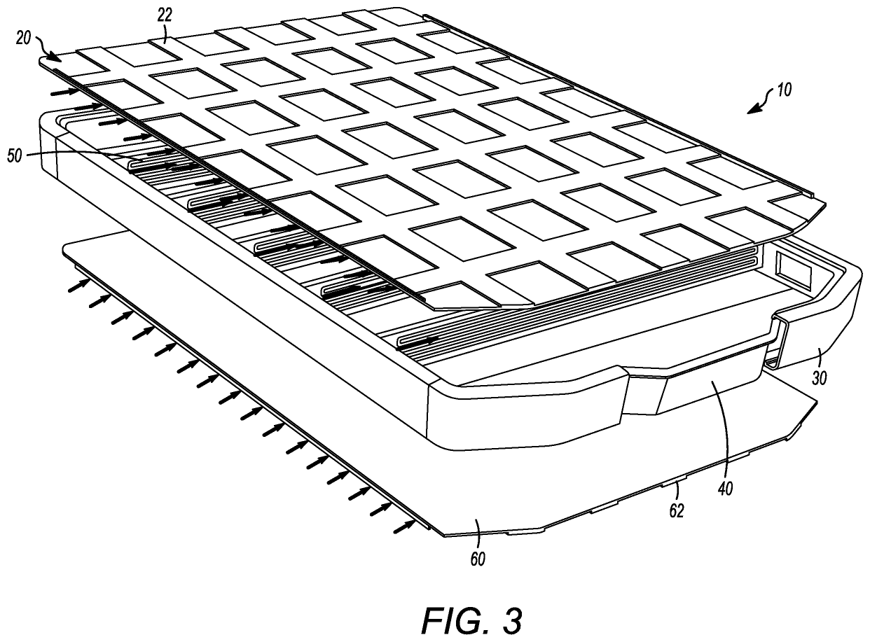

FIG. 3 illustrates example load distributions between components in the battery enclosure 10. As shown in FIG. 3, if a side impact event occurs at a side of the frame enclosure 30, the frame enclosure 30 may transfer at least a portion of the load to the bottom plate 60 (e.g., via a connection between a bottom portion of the frame enclosure and the bottom plate 60).

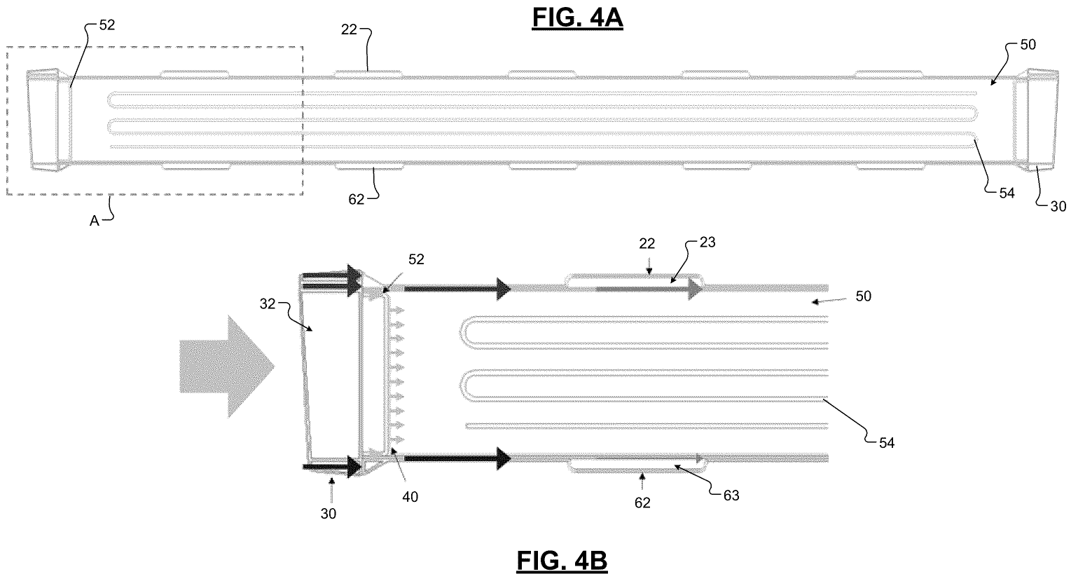

The frame enclosure 30 may transfer at least a portion of an impact load to the top plate 20 (e.g., via a connection between a top portion of the frame enclosure and the top plate 20). The frame enclosure 30 may transfer another portion of the load to the cross members 50. An example of transferring impact load from the frame enclosure to the cross members 50 is described further below with reference to FIG. 4B.

As shown in FIG. 3, the load received at the side of the frame enclosure 30 may be transferred and shared across the top plate 20, the bottom plate 60, and the cross members 50. This may increase the structural integrity of the battery enclosure 10, and reduce the likelihood of damaging the battery pack housed in the battery enclosure 10 during an impact event such as a crash.

The top plate 20 includes multiple ridges 22, which may increase the structural support and stiffness of the top plate 20. For example, each ridge 22 may include two channel walls that protrude upwards from a top surface of the top plate 20, and an upper wall that connects the two channel walls.

An example cross-sectional view of a ridge 22, which is part of the top plate 20, is shown in FIGS. 4A and 4B. The channel walls of the ridge 22 define a channel 23. The channel 23 can be an open or closed section. For example, the upper wall of the ridge 22 may be substantially parallel with the top surface of the top plate 20, to define the channel 23 between the top plate 20 and the upper wall and channel side walls of the ridge 22. The ridge 22 may be considered as an offset feature, where the upper wall of the ridge 22 is offset from the top surface of the top plate 20. In various implementations, the ridge 22 may be closed with an additional base plate, as part of the top plate 20 that is a separate layer from the layer where the ridge 22 is added. The size, shape, location, etc. of the ridge 22 may be optimized though computer-aided engineering (CAE) analysis.

Returning again to FIGS. 1-3, the top plate 20 may include multiple ridges 22 in various orientations. For example, a first portion of the ridges 22 may extend in a first direction substantially parallel to a length dimension of the top plate 20, and a second portion of the ridges 22 may extend in a second direction substantially perpendicular to the first direction. Therefore, ridges 22 may intersect one another at, e.g., approximately right angles.

Although FIGS. 1-3 illustrate five ridges 22 extending in a length dimension of the top plate 20, and six ridges 22 extending in a width dimension of the top plate 20, other example embodiments may include more or less ridges, ridges extending in other directions, etc.

Returning again to FIGS. 4A and 4B, the channels 23 defined by the ridges 22 of the top plate 20 may define an enclosed space for flow of cooling and/or heating fluid (e.g., a heat transfer medium). For example, a fluid such as coolant liquid, air, etc. may be circulated through the channels 23 to control temperature of the battery enclosure 10 and provide improved heat transfer for the battery pack within the battery enclosure 10.

In various implementations, a cooling and/or heating fluid may flow directly through the channels 23, where the channels 23 provide an enclosure to inhibit or prevent a fluid in the channels 23 from escaping to ambient air outside the battery enclosure 10. Alternatively, or additionally, tubing may be routed within the channels 23 to provide a flow of fluid through the channels 23 via the tubing.

Similar to the ridges 22 of the top plate 20, the bottom plate 60 may consist of a multi-layer structure and include ridges 62 that protrude from, e.g., a bottom surface of the bottom plate 60. The ridges 62 of the bottom plate 60 may increase structural stiffness of the bottom plate 60, provide for additional thermal control and heat transfer characteristics of the bottom plate 60, etc.

For example, the ridges 62 of the bottom plate 60 may define multiple channels 63 for flow of a cooling and/or heating fluid. Similar to the channels 23 of the ridges 22 of the top plate 20, the channels 63 of the ridges 62 of the bottom plate 60 may enclose a channel space to allow fluid to flow directly in the channels 63, may include tubing routed through the channels 63 to control a flow of fluid in the channels 63, etc. Using an enclosed channel space for direct fluid flow may allow for reducing or eliminating a need for running coolant piping or tubing.

In various implementations, one or more airflow deflectors may be used to divert air beneath the vehicle into the channels 63 of the bottom plate 60. For example, an airflow deflector may be located on an underside of the vehicle upstream of the bottom plate 60, and may include a surface angled to divert airflow while driving into an opening of the channels 63. This may facilitate enhanced cooling of the battery pack via the channels 63 of the bottom plate 60.

The vehicle may be any suitable type of vehicle, including an electric vehicle such as a battery electric vehicle (BEV), a hybrid vehicle, or a fuel cell vehicle, a vehicle including an internal combustion engine (ICE), or other type of vehicle. For example, a battery pack housed in the battery enclosure 10 may provide power to or receive power from an electric motor of a drive unit via a power inverter during propulsion or regeneration.

The battery system housed in the battery enclosure 10 may include any suitable arrangement of the battery pack, BMS, etc. for providing power to components of the vehicle. For example, the battery system may supply power to drive an electric motor of the drive unit, may supply power to operate a vehicle monitoring module, a wireless communication interface, a telematics unit, a cabin comfort system, etc. The battery system may output voltages at one or more levels, such as a high voltage level (e.g., 110V, 120V, 200V, 208V, 240V, 400V, 600V, 800V, etc.) to power vehicle components that operate on higher voltages, and a low voltage level (e.g., 3.3V, 5V, 12V, 24V, 48V, etc.) to power vehicle components that operate on lower voltages.

The vehicle may include a vehicle control module configured to control operation of one or more vehicle components, such as the battery system. For example, the vehicle control module (which may include a battery management system), may include any suitable processing circuitry and memory to implement control functions, such as monitoring a temperature of the battery system, and controlling flow of cooling and/or heating fluid through the channels (e.g., channels 23 and 63 of FIG. 4B) to maintain the battery system temperature within a desired range.

Referring again to FIG. 4A, the cross member 50 may include one or more channels 54 for providing a flow of cooling and/or heating fluid to control heat transfer to and from the batteries. For example, a side surface of the cross member 50 may contact or be adjacent to one or more batteries. The channels 54 may allow a flow of fluid to maintain a desired temperature range of the batteries.

The channel(s) 54 may be located on an outer surface of the cross member 50, within an interior of the cross member 50, etc. For example, the channel(s) 54 may be integrated into the cross member 50, may be added as a joined component, etc. Although FIG. 4A illustrates the channel 54 as having an alternating S-shape pattern, other example embodiments may include more or less channels 54 having other shapes in the cross member 50.

FIG. 4B illustrates an example side impact force on a side wall of the frame enclosure 30. As shown in FIG. 4B, the impact force is transferred from the frame enclosure 30, through the bracket 52, to an end of one or multiple cross members 50. The load is then distributed along the cross member 50. The bracket 52 may be located on a side wall of the tray 40, to transfer the impact load to the end of the cross member 50 that contacts the side wall of the tray 40. The bracket 52 may be in contact with at least one cross member 50. In various implementations, an alternative design of the bracket 52 may include a larger component that is connected to multiple cross members 50.

The frame enclosure 30 may define a cavity space 32 (e.g., a crumple zone), which may be inside the frame enclosure 30. For example, the cavity space 32 may provide clearance to allow the side wall of the frame enclosure 30 to deform at least partially, in response to an impact force, without damaging a battery pack housed in the tray 40.

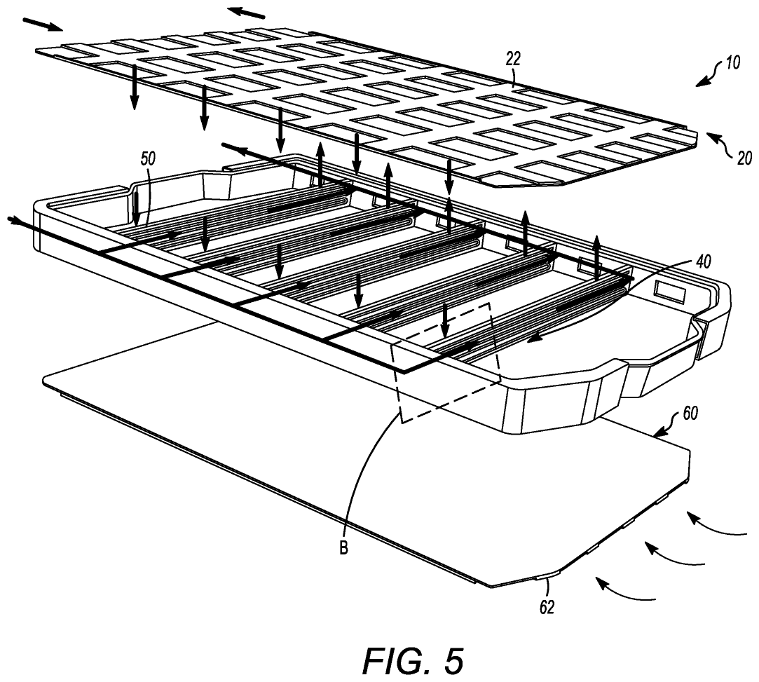

FIG. 5 illustrates example flow paths for cooling and/or heating fluid in the battery enclosure 10. For example, and as described above, fluid may be controlled to flow through various channels of the top plate 20, the bottom plate 60, the cross members 50, and within a cavity space 55 of the frame enclosure 30. The cavity space 55 may be defined between the side wall of the frame enclosure 30 and the sidewall of the tray 40, or the battery pack in the absence of a tray.

In an example path, fluid may enter a cavity space 32 on one side of the frame enclosure 30, travel across the cross members 50 (e.g., via a fluid connection between the cavity space 55 and the channels 54 of the cross members 50), and then return to, e.g., a fluid reservoir, etc. along a cavity space 55 on an opposite side.

As another example path, fluid may enter channels 23 of the ridges 22 of the top plate 20 on a first side of the top plate 20, and travel down into the channels 54 of the cross members 50 (e.g., via a direct fluid connection between the channels 23 of the top plate 20 and the channels 54 of the cross members 50, via an intermediate fluid connection in the cavity space 55, etc.). The fluid may then travel across the cross members 50, and go back up into channels 23 of the top plate 20 on an opposite side of the top plate 20, before returning to a fluid reservoir, etc.

As described above, the fluid may flow through the channels themselves, through tubing that is routed through the channels, etc. Although FIG. 5 illustrates two example flow paths for fluid through the channels of the structural features of the battery enclosure 10, it should be apparent that other embodiments may include other suitable types of fluid flow paths through more or less channels and components of the battery enclosure, in different directions through the channels, etc.

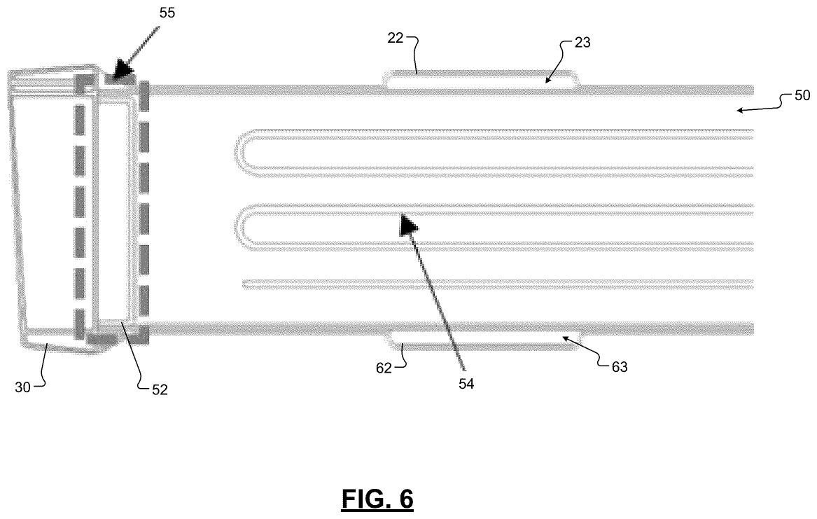

FIG. 6 illustrates a side view of a portion of the cross member 50, and frame enclosure 30, showing an example cavity space 55. The cavity space 55 may be similar or different from the cavity space 32 illustrated in FIG. 4B. For example, the cavity space 55 may be located adjacent brackets 52, may be located interior of the frame enclosure 30 and the cavity space 32 that serves as a crumble zone, etc. Very limited deformation may be allowed in the cavity space 55.

As described above, fluid flow may be routed through the frame enclosure 30. As shown in FIG. 6, the cavity space 55 may provide room for routing tubing for fluid flow, for allowing fluid to flow directly, etc. The cavity space 55 may be useful in routing fluid to the cross members 50, so that the fluid can travel through the built-in channels 54 in the cross members 50.

In various implementations, the channels, clearance spaces, etc., may be used to allow fumes to escape the battery enclosure 10. For example, a thermal vent may be in fluid communication with one or more channels, clearance spaces, etc., to allow fumes from the battery compartment to escape to outside air.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

What is claimed is:

1. A battery enclosure to house a battery pack of an electric vehicle, the battery enclosure comprising:
a bottom plate including at least a top surface and a bottom surface;
a battery pack including multiple batteries or battery modules configured to store energy for the electric vehicle;
a frame enclosure at least partially surrounding the battery pack, the frame enclosure connected with the bottom plate, the frame enclosure including at least a first side wall and a second side wall opposite the first side wall;
multiple cross members, each cross member extending between the first side wall and the second side wall; and
a top plate configured to cover the multiple structural cross members and at least a portion of the battery pack, the top plate connected with the frame enclosure, the top plate including multiple ridges protruding from a top surface of the top plate, each ridge defining a channel extending parallel to the top surface of the top plate, and each channel configured to facilitate flow of a heat transfer medium through the channel.

2. The battery enclosure of claim 1, further comprising a tray on the top surface of the bottom plate, the tray configured to house the battery pack, the tray including at least a first tray side wall and a second tray side wall opposite the first tray side wall;
wherein the frame enclosure at least partially surrounds the tray, and each cross member extends from the first tray side wall to the second tray side wall.

3. The battery enclosure of claim 1, wherein the heat transfer medium includes at least one of a coolant liquid and air.

4. The battery enclosure of claim 3, wherein:
the bottom plate includes multiple ridges protruding from the bottom surface;
each ridge of the bottom plate defines a channel extending parallel to the bottom surface; and
each channel of the bottom plate is configured to facilitate flow of the heat transfer medium through the channel.

5. The battery enclosure of claim 4, further comprising at least one air deflector angled to direct airflow from beneath the electric vehicle into at least one channel of the bottom plate.

6. The battery enclosure of claim 1, wherein:
each ridge includes two channel side walls extending upwards from the top surface of the top plate, and an upper wall connected between the two channel side walls; and
the upper wall is parallel with the top surface of the top plate.

7. The battery enclosure of claim 6, further comprising a tube extending through at least one channel to provide a flow of coolant liquid through the at least one of the channels.

8. The battery enclosure of claim 1, wherein:
a first portion of the multiple ridges extend in a first direction parallel to a length dimension of the top plate; and
a second portion of the multiple ridges extend in a second direction perpendicular to the first direction.

9. The battery enclosure of claim 8, wherein each of the multiple ridges in the first portion intersects at least one of the multiple ridges in the second portion.

10. The battery enclosure of claim 1, wherein the top plate is configured to connect to a floor pan of a body of the electric vehicle to provide structural support for the top plate.

11. The battery enclosure of claim 2, wherein the tray is configured to hermetically seal the battery pack within the battery enclosure.

12. The battery enclosure of claim 1, wherein the frame enclosure is configured to fully enclose the battery pack with the bottom plate, to hermetically seal the battery pack.

13. A battery enclosure for a battery pack of an electric vehicle, the battery enclosure comprising:
a bottom plate including at least a top surface and a bottom surface;
a battery pack including multiple batteries or battery modules configured to store energy for the electric vehicle;
a frame enclosure at least partially surrounding the battery pack, the frame enclosure connected with the bottom plate, the frame enclosure including at least a first side wall and a second side wall opposite the first side wall;
multiple cross members, each cross member extending between the first side wall and the second side wall, each cross member defining multiple channels extending along the cross member, and each channel configured to facilitate flow of a heat transfer medium through the channel; and
a top plate configured to cover the multiple cross members and at least a portion of the battery pack, the top plate connected with the frame enclosure.

14. The battery enclosure of claim 13, further comprising a tray on the top surface of the bottom plate, the tray configured to house the battery pack, the tray including at least a first tray side wall and a second tray side wall opposite the first tray side wall;
wherein each cross member extends from the first tray side wall to the second tray side wall.

15. The battery enclosure of claim 13, wherein the heat transfer medium includes at least one of a coolant liquid and air.

16. The battery enclosure of claim 13, wherein each of the multiple batteries or battery modules is between two of the multiple cross members.

17. The battery enclosure of claim 14, wherein a height of each cross member between the tray and a bottom surface of the top plate is greater than a width of the cross member.

18. The battery enclosure of claim 14, further comprising multiple side brackets, wherein:
each side bracket is located between the frame enclosure and the first tray side wall or the second tray side wall; and
each side bracket is aligned with an end of one or more of the multiple cross members to transfer load to one or more of the multiple cross members.

19. The battery enclosure of claim 17, wherein the frame enclosure is on an outer periphery of the battery pack, and the frame enclosure defines a crumple zone configured to allow deformation of the frame enclosure in response to a side impact of the battery enclosure.

20. A battery enclosure for a battery pack of an electric vehicle, the battery enclosure comprising:
a bottom plate including at least a top surface and a bottom surface, the bottom plate including multiple ridges protruding from the bottom surface, each ridge defining a channel extending parallel to the bottom surface;
a battery pack including multiple batteries or battery modules configured to store energy for the electric vehicle;
a frame enclosure at least partially surrounding the battery pack, the frame enclosure connected with the bottom plate, the frame enclosure including at least a first side wall and a second side wall opposite the first side wall;
multiple cross members, each cross member extending between the first side wall and the second side wall; and
a top plate configured to cover the multiple cross members and at least portion of the battery pack, the top plate connected with the frame enclosure, the top plate including multiple ridges protruding from a top surface of the top plate, and each ridge of the top plate defining a channel extending parallel to the top surface of the top plate.
